(19) United States
(12) Patent Application Publication
(10) Pub. No.: US 2026/0060179 A1
(43) Pub. Date: Mar. 5, 2026

(54) A Grain Cleaning Apparatus for a Combine Harvester

(71) Applicant: AGCO International GmbH, Neuhausen (CH)

(72) Inventors: Jonas Toft Andersen, Randers (DK); Peter Birkedal, Randers (DK)

(21) Appl. No.: 19/105,151

(22) PCT Filed: Jul. 5, 2023
(86) PCT No.: PCT/IB2023/056953

§ 371 Date: Feb. 20, 2025

(30) Foreign Application Priority Data
Aug. 24, 2022 (GB) 2212331.9

(51) Int. Cl. A01D 75/28; A01F 12/44

(52) U.S. Cl. CPC A01D 75/282; A01F 12/444; A01F 12/448

(57) ABSTRACT

A grain cleaning apparatus comprises a stratification pan for receiving material from a threshing system of a combine harvester. Material is divided into lanes on the stratification pan by dividers, and at least some of the dividers are provided with a respective pivotable guide plate for guiding material into a lane at a selected side of the divider. The pivoting of the guide plates is controlled in dependence on a lateral inclination of the combine harvester.

### CROSS-REFERENCE TO RELATED APPLICATION

This application claims priority to United Kingdom Application No. GB2212331.9, filed 24 Aug. 2022, which is incorporated herein by reference in its entirety.

### FIELD

Embodiments of the present disclosure relate generally to combine harvesters, and in particular to the grain cleaning system used within a combine harvester.

### BACKGROUND

A combine harvester typically includes a threshing system for detaching grains of cereal from the ears of cereal, a separating apparatus downstream of the threshing system, and a grain cleaning apparatus for receiving grain from the separating apparatus. The grain is collected in a grain tank, and from the grain tank the grain can be unloaded by a grain unloading system, for example to a trailer pulled by a tractor which runs alongside the combine harvester.

The initial threshing creates a flow of grain to a stratification pan of the separating apparatus. The separating function further downstream of the threshing system serves to separate further grain from the crop stream and this separated grain passes through a grate-like structure onto an underlying return pan. The stratification pan and return pan are driven in an oscillating manner to convey the grain and MOG accordingly.

The crop stream collected by the stratification pan and return pan typically includes a proportion of straw, chaff, tailings and other unwanted material such as weed seeds, bugs, and tree twigs. The grain cleaning apparatus removes this unwanted material thus leaving a clean sample of grain to be delivered to the tank. A grain cleaning unit for example comprises a fan unit and sieves, the main sieve being known as the chaffer. The sieves are also driven with an oscillatory movement to transport the grain towards the grain tank. In particular, there is a fore/aft motion with a vertical component.

When operating on a hillside, the crop stream will also be collected on the stratification pan, from the threshing system, with a non-uniform distribution. This non-uniform distribution results in less efficient separation of grain, and results in an uneven distribution being delivered to the grain cleaning apparatus.

It is known to provide hillside compensation for the operation of the cleaning system. A sieve motion is used to compensate for the tendency for the grain to slope to the side. In particular, a side-to-side oscillatory component is added to the sieve shaking movement. This side-to-side movement can also be used to promote an even distribution of grain, even when operating on the flat.

It would be beneficial to provide a more uniform delivery of material to the cleaning system.

### BRIEF SUMMARY

The invention is defined by the claims.

According to examples in accordance with the invention, there is provided a grain cleaning apparatus for a combine harvester, comprising:
a stratification pan for receiving material from a threshing system of the combine harvester;
a set of dividers for dividing the material into lanes on the stratification pan, the dividers comprise partition walls which extend normally upwardly from a base plane of the stratification pan, the lanes extending in a fore-aft direction of the combine harvester, wherein at least some of the dividers are provided with a respective pivotable guide plate for guiding material into a lane at a selected side of the divider, wherein the guide plates each extend upwardly from the top of a respective divider and are pivoted at the top of the respective divider; and
a controller configured to control the pivoting of the guide plates in dependence on a lateral inclination of the combine harvester.

The guide plates are used to direct material falling from the threshing system to particular lateral areas (lanes) of the stratification pan. By pivoting the guide plates in dependence on the angle of inclination, the material can directed such that a more uniform distribution results on the stratification pan. For example, if tilting down to the right, there will be a tendency for material to collect at the right side of the stratification pan. The guide plates will then rotate right (clockwise) to block material reaching the right lateral edge and instead steer some of the material towards the next more innermost lane of the stratification pan. Thus, the “selected”side of the divider is the side opposite to where the guide plate is positioned.

The controller is for example configured to pivot the guide plates in unison in the same rotational direction. Thus across the width of the stratification pan, the material is directed more towards the left or right, depending on the angle of inclination.

The dividers comprise partition walls which extend normally upwardly from a base plane of the stratification pan. Thus, they define upright lanes. The guide plates each extend upwardly from the top of a respective divider and are pivoted at the top of the respective divider. Thus, they are above the general area of the stratification pan and guide material as it falls towards the stratification pan.

The dividers for example comprise a central divider with a central guide plate extending along a central length axis of the stratification pan, and lateral dividers with lateral guide plates. Thus, there are guide plates distributed across the width of the stratification pan.

In response to a horizontal orientation, the central guide plate may extend normally upwardly from a base plane of the stratification pan, and the lateral guide plates are positioned with an outward pivoted orientation for guiding material away from the outermost lateral regions of the stratification pan. This may be considered to be a default orientation. Rather than having all the guide plates directed normally upwardly, they may already perform a redistribution function, directing material more toward the middle of the stratification pan. This compensates for the natural tendency for material to be more densely gathered at the edges, as a result of the nature of the threshing system from which the material is received.

The grain cleaning apparatus for example comprises an inclination sensor for sensing an angle of lateral inclination of the combine harvester. In practice, the inclination sensor is a main central part of the combine harvester rather than being introduced as part of the grain cleaning apparatus.

The grain cleaning apparatus for example further comprises:
a fan; and
a sieve arrangement for receiving the harvested crop material from a rear end of the stratification pan.

The sieve arrangement for example comprises a chaffer sieve for conveying harvested crop material in a generally rearward direction and a lower sieve. A clean grain chute is then provided below the lower sieve.

A second chute is for example provided for directing tailings to a tailings collection trough.

The invention also provides a grain processing system for a combine harvester, comprising:
a threshing system;
a separating system; and
the grain cleaning apparatus as defined above, wherein the stratification pan is for receiving the harvested crop material from the threshing system.

The grain cleaning apparatus for example further comprises a return pan for receiving the harvested crop material from the threshing system and wherein the stratification pan is for receiving the harvested crop material from a front end of the return pan.

The invention also provides a combine harvester comprising:
a crop cutting head; and
the grain processing system as defined above for receiving the cut and threshed crop material.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 shows a combine harvester which may be adapted in accordance with the invention;

FIG. 2 shows one example of threshing system and grain cleaning apparatus in more detail;

FIG. 3 shows another example of threshing system and grain cleaning apparatus;

FIG. 4 shows a grain cleaning apparatus in accordance with the invention;

FIG. 5 shows one example of angular control of the guide plates of the grain cleaning apparatus; and

FIG. 6 shows another example of angular control of the guide plates of the grain cleaning apparatus.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure relates to the grain cleaning apparatus of a combine harvester, and in particular relates to an arrangement for compensating for the angle of inclination of the combine harvester to improve the uniformity of the distribution of material on the stratification pan of the grain cleaning apparatus. However, the general configuration of a combine harvester will first be described.

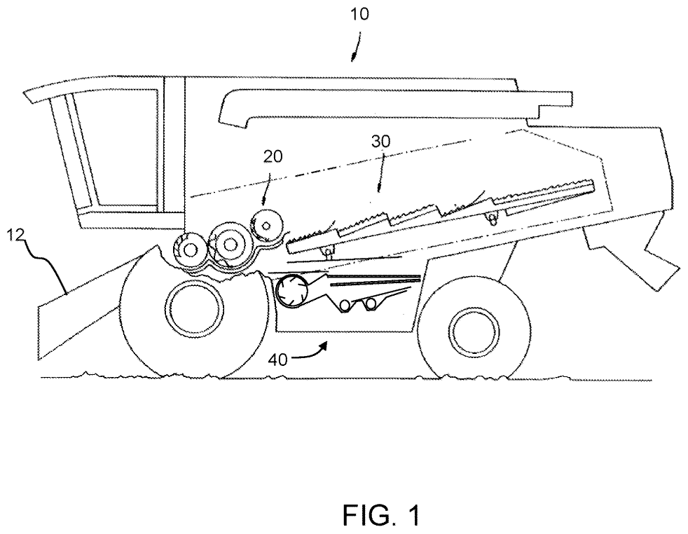

FIG. 1 shows a known combine harvester 10 to which the invention may be applied. The combine harvester includes a threshing unit 20 for detaching grains of cereal from the ears of cereal, and a separating apparatus 30 which is connected downstream of the threshing unit 20. The threshing system comprises one or more threshing units, in particular rotors, and associated concaves.

In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

The combine harvester has a front elevator housing 12 at the front of the machine for attachment of a crop cutting head (known as the header, not shown). The header when attached serves to cut and collect the crop material as it progresses across the field, the collected crop stream being conveyed up through the elevator housing 12 into the threshing unit 20.

In the example shown, the threshing system 20 is a tangential-flow ‘conventional’ threshing system, i.e. formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

There are also axial threshing systems, i.e. formed by rotating elements with an axis of rotation in the longitudinal direction (direction of travel). For example, the threshing section may have axially-aligned rasp bars spaced around the front section whilst the separating section has separating elements or fingers arranged in a pattern, e.g. a spiral pattern, extending from the rasp bars to the rear of the rotor.

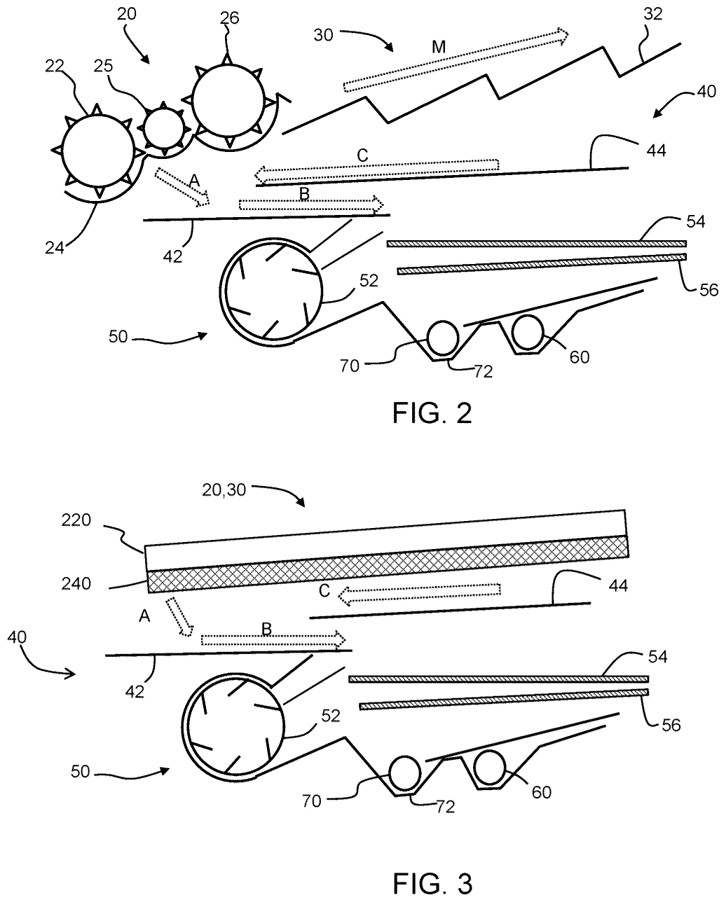

The conventional tangential flow threshing (and separating) unit 20 and separating device 30 are shown in FIG. 2 in more detail, together with a cleaning apparatus 40.

FIG. 2 shows one particular design of the threshing unit. The threshing unit 20 includes a rotor 22 (threshing cylinder) below which is mounted a concave 24 (a concave-shaped grate). The threshing cylinder 22 includes rasp bars (not shown) which act upon the crop stream to thresh the grain or seeds from the remaining material, the majority of the threshed grain passing through the underlying concave 24 and onto the stratification pan 42 (also known as the grain pan), which for convenience is in this disclosure considered to be part of the grain cleaning apparatus 40. The stratification pan 42 is typically divided into lanes by dividers, which maintain a distribution of crop material across the width of the stratification pan.

The threshing unit 20 also comprises a beater cylinder 25 (also with a transverse rotation axis and creating a tangential flow), downstream of the threshing cylinder and a tangential-flow multi-crop separator cylinder 26 (also with a lateral rotation axis and creating a tangential flow) downstream of the beater cylinder 25.

The remainder of the crop material including straw, tailings and un-threshed grain are passed from the threshing unit 20 into the separating apparatus 30 as shown by arrow M.

In the example shown, the separating apparatus 30 includes a plurality of parallel, longitudinally-aligned, straw walkers 32, and this is suitable for the case of a so-called straw-walker combine. However, the separating apparatus 30 may instead include one or two longitudinally-aligned rotors which rotate about a longitudinal axis and convey the crop stream rearwardly in a ribbon passing along a spiral path. This is the case for a so-called axial or hybrid combine.

There are also axial threshing systems, i.e. formed by rotating elements with an axis of rotation in the longitudinal direction (direction of travel).

An axial threshing (and separating) system 20,30 is shown in FIG. 3, together with the same cleaning apparatus 40 as in FIG. 2.

The threshing and separating functions are combined into a system 20,30 which comprises an axial rotor 220 beneath which is mounted the concave 240. The front section is a threshing section, and for example has axially-aligned rasp bars spaced around the front section. The separating section has separating elements or fingers arranged in a pattern, e.g. a spiral pattern, extending from the rasp bars to the rear of the rotor. The separating function involves conveying the crop stream rearwardly in a ribbon passing along a spiral path. FIG. 3 shows a single rotor 220, but there are single rotor and twin rotor systems (with two rotors in parallel).

This invention may be applied to any of the known threshing and separating systems.

In all cases, the separating apparatus 30 serves to separate further grain from the crop stream, and this separated grain passes through a grate-like structure onto an underlying return pan 44. The residue crop material, predominantly made up of straw, exits the machine at the rear. Although not shown in FIGS. 1 and 2, a straw spreader and/or chopper may be provided to process the straw material as required. The return pan 44 extends to the back of the crop flow, and in some designs there is an additional front return pan at the front of the crop flow.

The threshing apparatus 20 and separating apparatus 30 do not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 (i.e. a grain cleaning unit 50) is provided to remove this unwanted material thus leaving a clean sample of grain to be delivered to the tank.

For clarity, the term ‘grain cleaning apparatus’ is intended to include the stratification pan 42, the return pan 44 and other parts which form the grain cleaning unit 50 (also known as a cleaning shoe).

The grain cleaning unit 50 also comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The grain passing through concave grate 24 falls onto the front of the stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the grate of the separator apparatus 30 falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and on top of the material conveyed from the threshing unit 20 as indicated by arrow B.

The combined crop streams thus progress rearwardly towards a rear edge of the stratification pan 42. Whilst conveyed across the stratification pan 42, the crop stream, including grain and MOG, undergoes stratification wherein the heavier grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the heavier grain to pass through the chaffer onto an underlying second sieve 56.

The chaffer 54 is coarser (with larger holes) than second sieve 56. Grain passing through chaffer 54 is incident on the lower sieve 56 which is also driven in an oscillating manner and serves to remove tailings from the stream of grain before being conveyed to on-board tank (not shown) by grain collecting auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner. The grain collecting auger 70 delivers the grain to a grain tank, and a grain unloading system enables the grain to be removed from the grain tank.

The invention relates to the control of the flow of material onto the stratification pan. In known manner, material is divided into lanes on the stratification pan by dividers. At least some of the dividers are provided with a respective pivotable guide plate for guiding material into a lane at a selected side of the divider. The pivoting of the guide plates is controlled in dependence on a lateral inclination of the combine harvester.

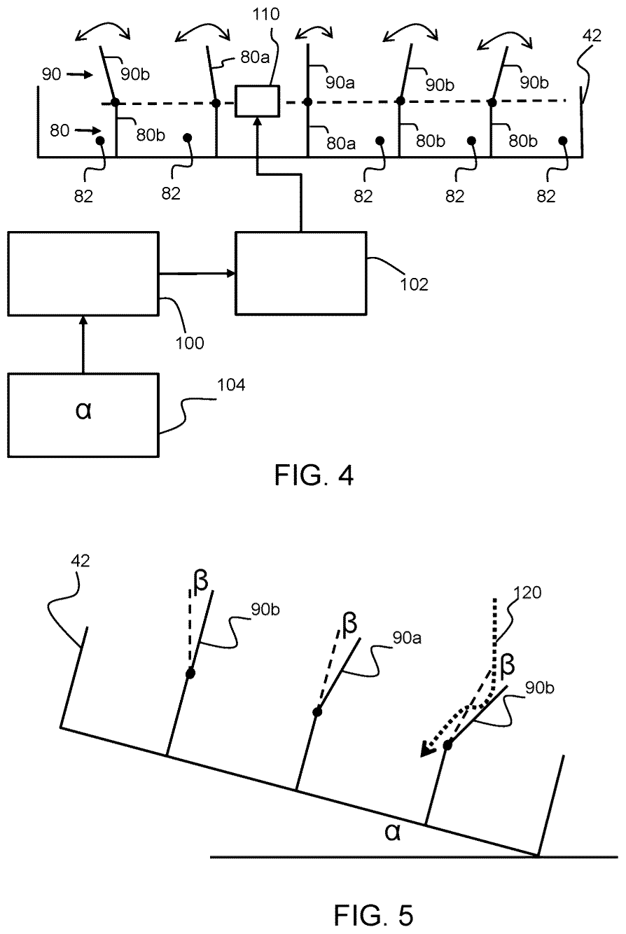

FIG. 4 shows the parts of a grain cleaning apparatus which are modified by the concept of the invention. It shows the stratification pan 42 in end view (hence viewed along the fore-aft direction of the combine harvester). A set of dividers 80 is provided for dividing the material into lanes 82 on the stratification pan, with the lanes 82 extending in a fore-aft direction of the combine harvester. The dividers 80 comprise partition walls which extend normally upwardly from a base plane of the stratification pan.

In this example, each divider 80 has a respective pivotable guide plate 90 for guiding material which is being received from above into a selected lane. The selected lanes is at one or other side of the divider 80. In this way, more or less material is allowed to fall into each individual lane. The guide plates 90 each extend upwardly from the top of a respective divider 80, and there is a pivot connection between the top of the divider and the bottom of the guide plate.

A controller 100 configured is used to drive an actuator 102 which controls the pivoting of the guide plates 82 about their pivot connections in dependence on a lateral inclination a of the combine harvester. This lateral angles is measured by an inclination sensor 104. An inclination sensor 104 is used for sensing the angle a of lateral inclination of the combine harvester and this sensing information is provided to the controller 100.

FIG. 4 shows that the dividers 80 comprise a central divider 80a with a central guide plate 90a extending along a central length axis of the stratification pan, and lateral dividers 80b with lateral guide plates 90b. The example of FIG. 3 has six lanes, separated by five dividers, but this is simply one possible example.

FIG. 4 shows the stratification pan in a horizontal (lateral) orientation, and this may be considered to be a default orientation. In this orientation, central guide plate 90a extends normally upwardly from a base plane of the stratification pan, whereas the lateral guide plates 90b are positioned with an outward pivoted orientation for guiding material away from the outermost lanes of the stratification pan (and hence towards the lanes which are set one lane in from the lateral outer edges. In this way, when there is zero inclination, the guide plates already perform a function of diverting the flow of material away from the lateral outer edges of the stratification pan and towards the center. This may be desirable for some designs of threshing system which tend to create a non-uniform distribution of material which is more dense at the lateral edges.

The control based on the lateral inclination enables this more uniform distribution to be maintained even when the combine harvester is operating at a lateral slope. The tendency would be for material to flow to the downhill side of the stratification pan, so the guide plates are each used to divert material towards the next uphill lane. For this purpose, all of the guide plates rotate towards the downhill side. The guide plates for example try to overcompensate the material distribution on the stratification pan instead of keeping it uniform, but as the material walks through the combine the distribution will even out and become more uniform on the chaffer.

The guide plates for example pivot in unison in the same rotational direction. Thus, a single control input 110 may be used to control the movement of all of the guide plates.

FIG. 5 shows one example of the pivoting control of the guide plates 90 in response to an inclination angle α with the right side downhill. Three dividers and guide plates are shown in this example. In this case, all of the guide plates are rotated in same direction by an angle β relative to the orientation in the default position (which is shown dotted). The angle β may be the same as α, or there may be a mapping between α and β. Arrow 120 shows how falling material that would have reached the rightmost lane is deflected further towards the middle of the stratification pan.

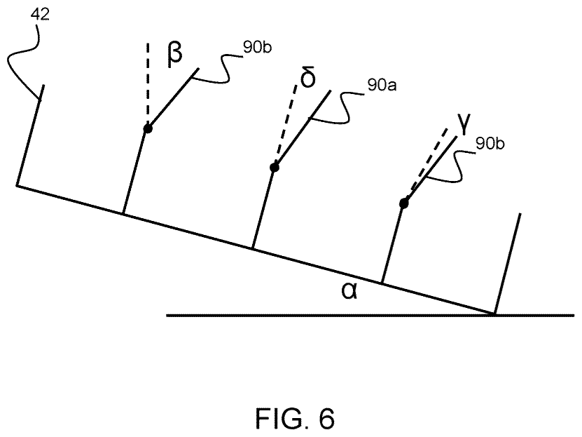

FIG. 6 shows another example of the pivoting control of the guide plates 90 in response to an inclination angle α with the right side downhill. In this example, the guide plates are rotated in the same direction but by different angles β, δ, γ. The arrangement shown provides the overcompensation as explained above. Different angles may be achieved by having different gearing between a single control input and individual driving systems for each guide plate. The relationship between the angle of tilt and the pivot angle may also depend on the direction of tilt. For example, FIG. 5 shows a greatest angle of tilt (compared to the default positions) for the left hand downhill guide plate (i.e., γ<δ<β), so that for an opposite slope direction the left hand downhill guide plate will be pivoted the most (i.e. γ>δ>β).

The dividers and guide plates for example may extend along the full length of the stratification pan, or they may extend only partly along the length. The guide plates may extend along the same length as the dividers or they may be provided only along a portion of the length of the dividers.

In a more complex design, each guide plate may be controlled independently of the others, so that each may implement its own function of angle of tilt to the angle of inclination.

In the example above, the guide plates are pivotally attached to the dividers. However, they may instead have their own support structure and simply be positioned above the dividers. However, the pivotable guide plates may still be considered to be additional components associated with the dividers. Thus, the dividers may still be considered to be provided with a respective pivotable guide plate.

The example above has guide plates associated with each divider. However, there may be more dividers that guide plates. Thus, the guide plates may be used to direct material towards pairs of lanes rather than individual lanes.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a”or “an”does not exclude a plurality.

The mere fact that certain measures are recited in mutually different dependent claims does not indicate that a combination of these measures cannot be used to advantage.

If the term “adapted to” is used in the claims or description, it is noted the term “adapted to”is intended to be equivalent to the term “configured to”. Any reference signs in the claims should not be construed as limiting the scope.

All references cited herein are incorporated herein in their entireties. If there is a conflict between definitions herein and in an incorporated reference, the definition herein shall control.

1. A grain cleaning apparatus for a combine harvester, comprising:
a stratification pan for receiving material from a threshing system of the combine harvester;
a set of dividers for dividing the material into lanes on the stratification pan, the dividers comprise partition walls which extend normally upwardly from a base plane of the stratification pan, the lanes extending in a fore-aft direction of the combine harvester, wherein at least some of the dividers are provided with a respective pivotable guide plate for guiding material into a lane at a selected side of the divider, wherein the guide plates each extend upwardly from the top of a respective divider and are pivoted at the top of the respective divider; and
a controller configured to control the pivoting of the guide plates in dependence on a lateral inclination of the combine harvester.

2. The grain cleaning apparatus of claim 1, wherein the controller is configured to pivot the guide plates in unison in the same rotational direction.

3. The grain cleaning apparatus of claim 1, wherein the dividers comprise a central divider with a central guide plate extending along a central length axis of the stratification pan, and lateral dividers with lateral guide plates.

4. The grain cleaning apparatus of claim 3, wherein in response to a horizontal orientation, the central guide plate extends normally upwardly from a base plane of the stratification pan, and the lateral guide plates are positioned with an outward pivoted orientation for guiding material away from the outermost lateral regions of the stratification pan.

5. The grain cleaning apparatus of claim 1, comprising an inclination sensor for sensing an angle of lateral inclination of the combine harvester.

6. The grain cleaning apparatus of claim 1, further comprising:
a fan; and
a sieve arrangement for receiving the harvested crop material from a rear end of the stratification pan.

7. The grain cleaning apparatus of claim 6, wherein the sieve arrangement comprises a chaffer sieve for conveying harvested crop material in a generally rearward direction and a lower sieve, and the grain cleaning apparatus further comprises a clean grain chute below the lower sieve.

8. The grain cleaning apparatus of claim 7, comprising a second chute for directing tailings to a tailings collection trough.

9. A grain processing system for a combine harvester, comprising:
a threshing system;
a separating system; and
the grain cleaning apparatus of claim 1, wherein the stratification pan is for receiving the harvested crop material from the threshing system.

10. The grain processing system of claim 9, wherein the grain cleaning apparatus further comprises a return pan for receiving the harvested crop material from the threshing system and wherein the stratification pan is for receiving the harvested crop material from a front end of the return pan.

11. A combine harvester comprising:
a crop cutting head; and
the grain processing system of claim 9 for receiving the cut and threshed crop material.
